(19) United States
(12) Patent Application Publication
(10) Pub. No.: US 2023/0394433 A1
(43) Pub. Date: Dec. 7, 2023

(54) METHODS OF CONSTRAINT-BASED ALLOCATION OF PRODUCTS

(71) Applicant: Personalized Beauty Discovery, Inc., San Mateo, CA (US)

(72) Inventor: Jyotirmoy Sundi, Santa Clara, CA (US)

(21) Appl. No.: 17/831,703

(22) Filed: Jun. 3, 2022

(51) Int. Cl. G06Q 10/08

(52) U.S. Cl. CPC G06Q 10/0875

(57) ABSTRACT

Methods for performing constraint-based allocating of products are disclosed. One method performed is directed towards receiving product and choice groups data; declaring a model; determining a plurality of penalties; defining and minimizing a solver objective function for the model; calling the solver: and receiving status values. Another method is directed towards receiving product, choice groups data, and a plurality of elasticities data; creating first, second, and third loops defined to perform a number of iterations corresponding to the plurality of elasticities; declaring a model; creating a plurality of constraint-based loops; defining and minimizing a solver objective function for the model; calling the solver: and receiving status values prior to completing each third loop. Another method is directed towards receiving product and choice groups data; declaring a model; creating a plurality of loops wherein constraints are added; defining and minimizing a solver objective function for the model; and calling the solver.

### BACKGROUND

In the world of commerce, there are a plethora of business models that may be employed. In one such model, a vendor may wish to acquire products and offer the products to customers who could become subscribers, where a subscription service may offer a customer to receive products from a limited number of choice groups periodically (e.g., monthly).

In preparation of providing such subscription, the vendor could approach one or more manufacturers or wholesalers to purchase products in bulk, where making bulk purchases could result with lower costs of goods sold (COGS) per unit. Also, the number of units purchased for each product could vary from product to product. When the vendor receives or plans to receive products of different COGS and/or quantities, it could be faced with a predicament of product allocation for the next subscription cycle, i.e., the next time subscribers are provided with the limited number of choice groups.

In one business model that will provide the basis for the discussion that follows, the vendor has decided to create a program which provides its subscriber three products from three choice groups, one product from each choice group. One of the conditions set forth by the vendor may be that the total number of units of all of the products should be divided or balanced evenly across the three choice groups. For example, if the total number of units of all of the products is 300,000, then each choice group should be assigned with 100,000 units.

A second condition set forth by the vendor may be that all new products introduced in the next subscription cycle should be divided evenly or balanced across the three choice groups. For example, if the total number of units of new products is 90,000, then each choice group should be assigned with 30,000 units.

A third condition set forth by the vendor may be that all color products offered in the subscription should be divided evenly or balanced across the three choice groups. For example, if there are 30 color products, then each choice group should be assigned with 10 products.

A fourth condition set forth by the vendor may be that, for a number of choice groups equal to three, a first choice group include those products with the highest COGS among all of the products, a second choice group include those products with the lowest COGS, and a third choice group include those products with COGS in between.

A fifth condition set forth by the vendor may be related to whether the vendor has defined a hierarchy or tiered structure of products that categorizes a the brand of the product. As discussed herein, products branded as “famous,” “prestige,” and “hot” could be placed into a first tier, and products branded “spotlight,” “create,” “favorite,” and “empowered” could be placed into a second tier that is different from the first tier. In such as case, the vendor could set forth a fourth condition where each tier being offered in the subscription should be divided evenly or balanced across the three choice groups.

A sixth condition set forth by the vendor may be related to skins tones of the products. In such as case, the vendor could set forth a fifth condition where each skins tone of the products being offered in the subscription should be divided evenly or balanced across the three choice groups.

It would be highly improbable and likely impossible to find an exact solution in which each condition is met. When purchasing different amounts of products of differing COGS, it would be simply impossible to meet all of the conditions unless the purchases were preplanned ahead of the actual purchases. In such instances, a “best” solution will have to suffice, one that could be considered optimal” and/or “feasible” by a computer optimization tool known as a “solver.”

### SUMMARY

Embodiments of the inventive concepts disclosed herein are directed to an allocation system, device, and methods for injecting computer processing efficiency by iteratively determining and providing “best” solutions that could be considered by a solver as “optimal” and/or “feasible” when the vendor allocates products into choice groups as part of a subscription service offered to customers. The iterative solutions—employing constraint-based, optimization programming methods—provide “best” solutions because of the impossible task of finding an exact solution to conditions set forth by the vendor.

After data representative of the best solutions are obtained, each may be used as input data for computer simulations. Such simulations may be performed for matching the vendor's subscribers/customers with products in each choice group using subscriber profile data gained through its knowledge of the subscriber based upon, for example, previous purchases and/or expressed preferences. With this knowledge, the vendor may then decide which product from each of the three choice groups to send to its subscriber once the products have been allocated to one of the three choice groups employing the constraint-based, optimization programming methods disclosed herein.

In one aspect, embodiments of the inventive concepts disclosed herein are directed to a method for receiving product and choice groups data; declaring a model; determining a plurality of penalties; defining and minimizing a solver objective function for the model as a function of the penalties; calling the solver: and receiving status values.

In a further aspect, embodiments of the inventive concepts disclosed herein are directed to receiving product, choice groups data, and a plurality of elasticities data; creating first, second, and third loops defined to perform a number of iterations corresponding to the plurality of elasticities; declaring a model; creating a plurality of constraint-based loops; defining and minimizing a solver objective function for the model; calling the solver; and receiving status values prior to completing each third loop.

In a further aspect, embodiments of the inventive concepts disclosed herein are directed towards receiving product and choice groups data; declaring a model; creating a plurality of loops during the addition of constraints; defining and minimizing a solver objective function for the model; and calling the solver.

### BRIEF DESCRIPTION OF THE DRAWINGS

For a fuller understanding of the inventive embodiments, reference is made to the following description taken in connection with the accompanying drawings in which:

FIG. 1 depicts a table of twelve products for providing an illustrative example of utilizing iterative methods disclosed herein, in accordance with some embodiments;

FIGS. 2A through 2E illustrate general or generic java script code (code) disclosing the code underlying the invention presented herein, in accordance with some embodiments;

FIGS. 3A through 3F illustrate structures representative of various

decision variables and arrays, in accordance with some embodiments;

FIGS. 4A through 4D depict an exemplary embodiment of a flowchart disclosing a method of a constraint-based, optimization for the allocation of products, in accordance with some embodiments;

FIGS. 5A through 5G illustrate results produced by a solver using the product data of the table depicted in FIG. 1, in accordance with some embodiments; and

FIGS. 6A through 6H depicts a table of the eight results of FIGS. 5A through 5G, respectively, in accordance with some embodiments.

### DETAILED DESCRIPTION

In the following description, several specific details are presented to provide a thorough understanding of embodiments of the inventive concepts disclosed herein. One skilled in the relevant art will recognize, however, that the inventive concepts disclosed herein can be practiced without one or more of the specific details or in combination with other components. In other instances, well-known implementations or operations are not shown or described in detail to avoid obscuring aspects of various embodiments of the inventive concepts disclosed herein.

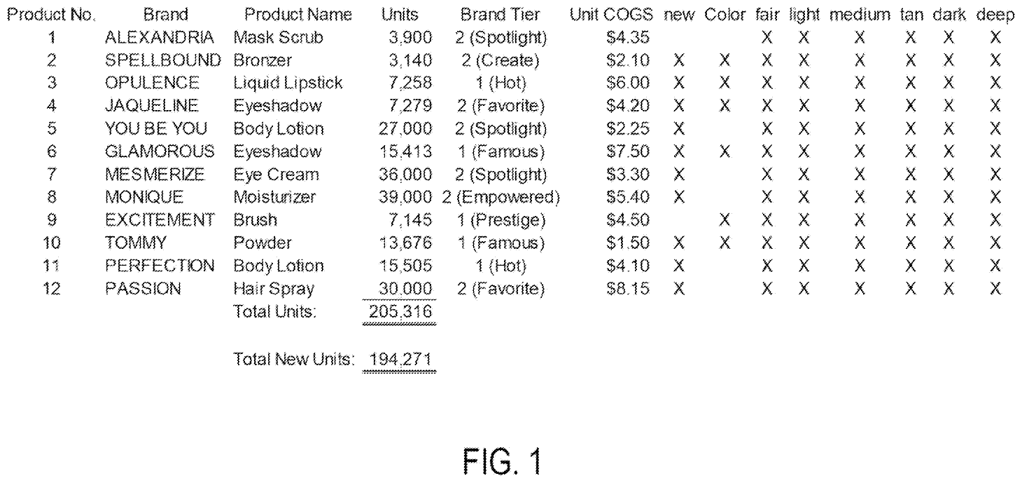

Referring now to FIG. 1, an illustrative example is presented in which twelve products are presented from which a vendor wishes to provide in a “choice group subscription model.” As shown, each product comprises a record with the following fields: a product number; a brand name, a product name, the number of units that will be available in an upcoming promotion; a brand tier (where tier 1 brands are categorized as famous, prestige and hot, and tier 2 brands are categorized as spotlight, create, favorite, and empowered); a unit cost or unit cost of goods sold (COGS), an indicator designating the product is new; an indicator designating the product as a color; and skin tones applicable for the product (fair, light, medium, tax, dark, and deep). In the detailed discussion that follows, these products will be used in an ongoing, instructive example. It should be noted that, although the discussion herein will be drawn to only twelve products for the sake of simplicity and brevity only, the embodiments herein are not limited to a relatively low number; rather, the embodiments herein may be employed with a greater number of products and/or greater number of fields.

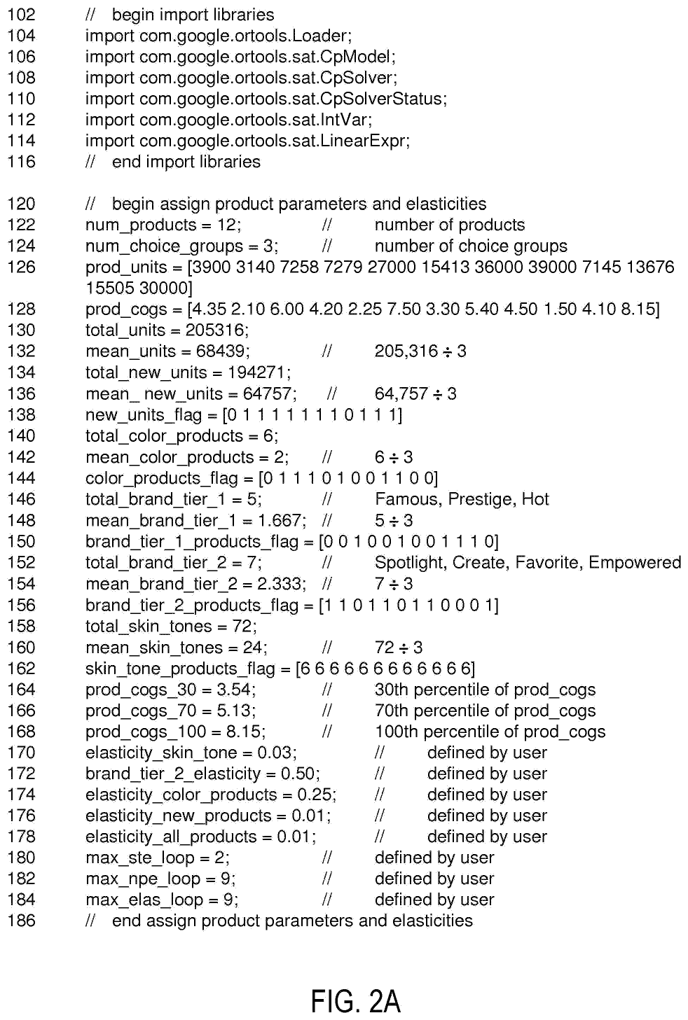

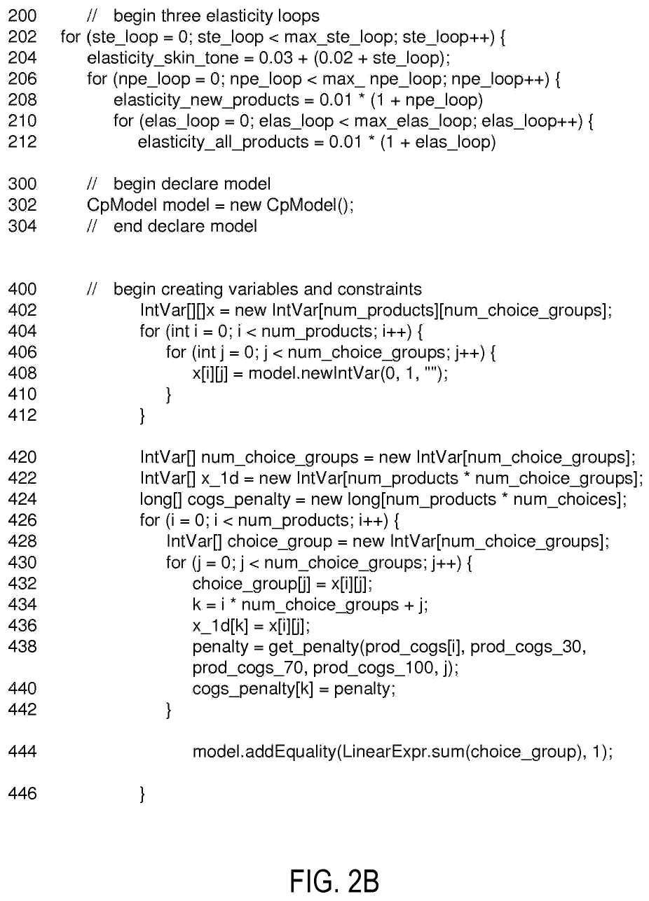

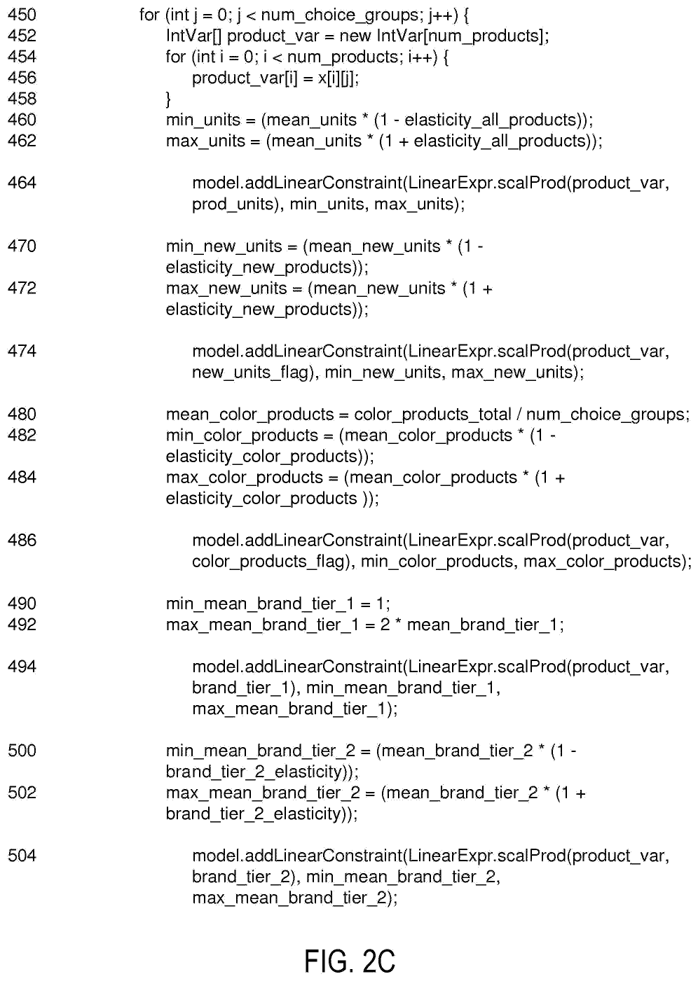

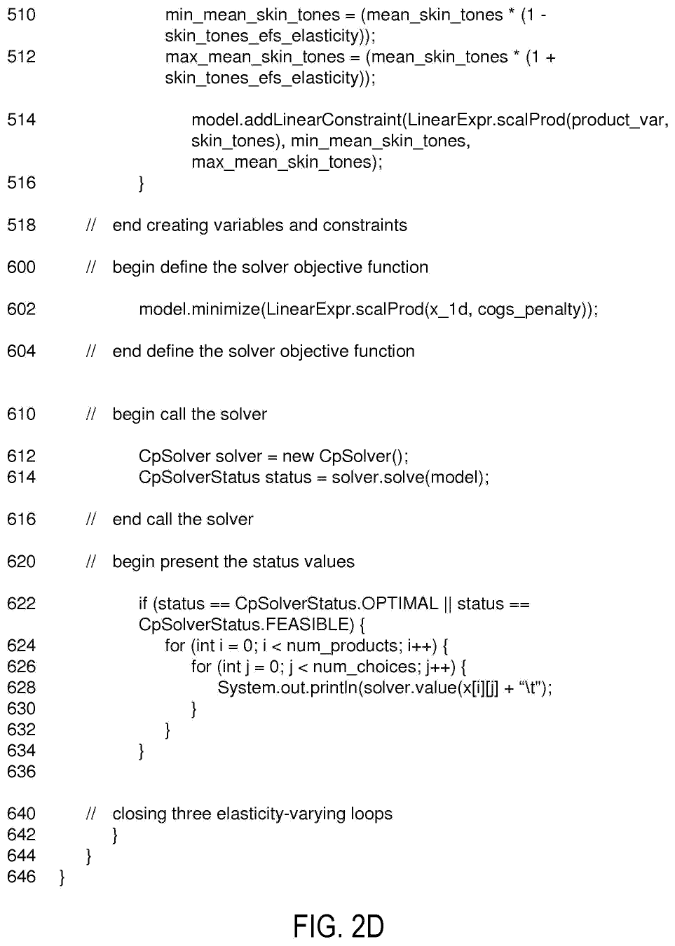

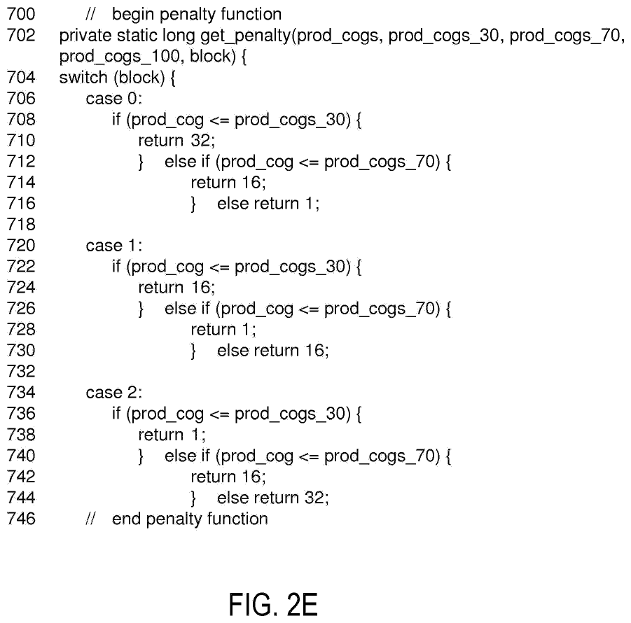

Referring now to FIGS. 2A-2E, general or generic java code (code) disclosing an embodiment of the invention is presented; it should be noted that although the exemplary code presented herein are drawn towards this code, the embodiments disclosed herein are not limited to java script but can be any code that is capable of performing the functions disclosed below including, but not limited to, python, C++ and C#.

In some embodiments, the disclosures herein may be performed by a processing unit(s) and/or a optimization system for the allocation of products including at least one processor unit(s) coupled to a non-transitory processor-readable medium(s) storing exemplary, processor-executable code presented in FIGS. 2A-2E, and configured and/or programmed to employ the constraint-based, allocation of products disclosed herein including, but not limited to, receiving data representative of product parameters and elasticities; if so, the exemplary code may be modified so that this data may be received from a source other than from within the code.

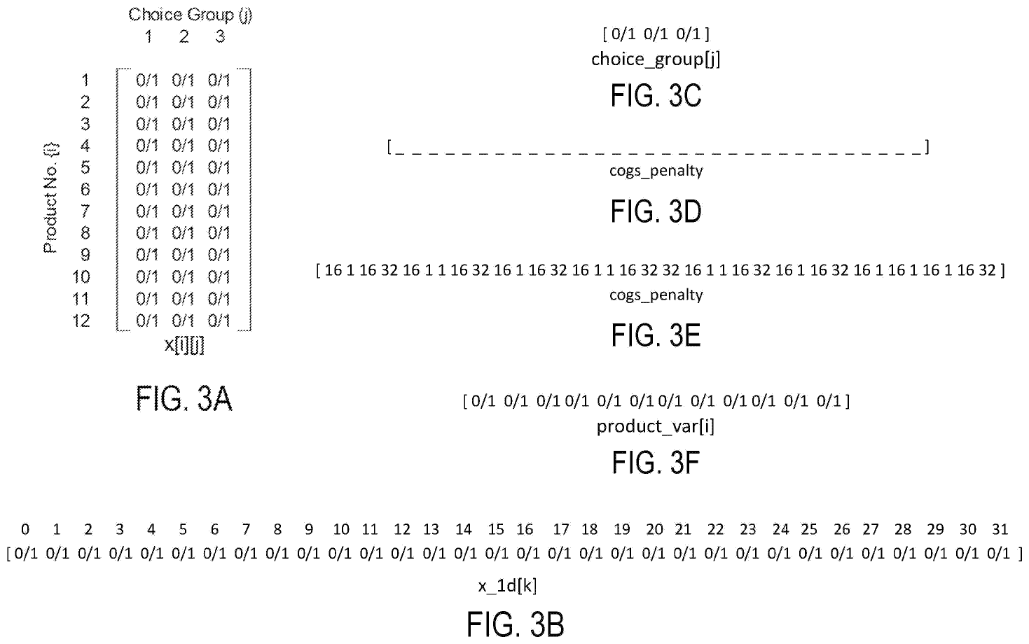

Referring now to FIGS. 3A-3F, structures representative of various decision variables and arrays are presented; each of these will be discussed in below.

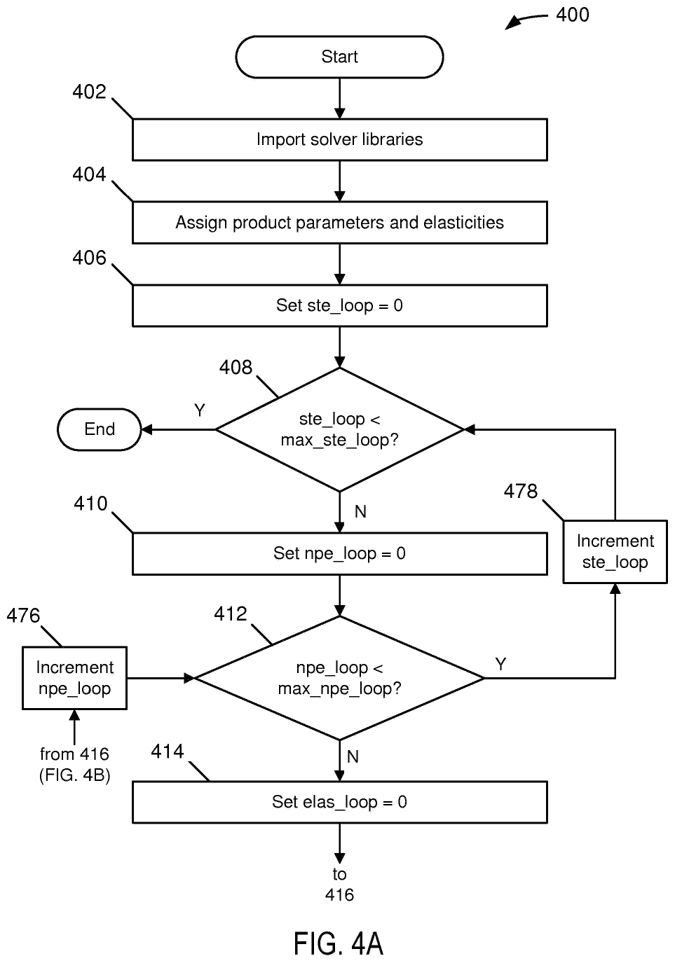

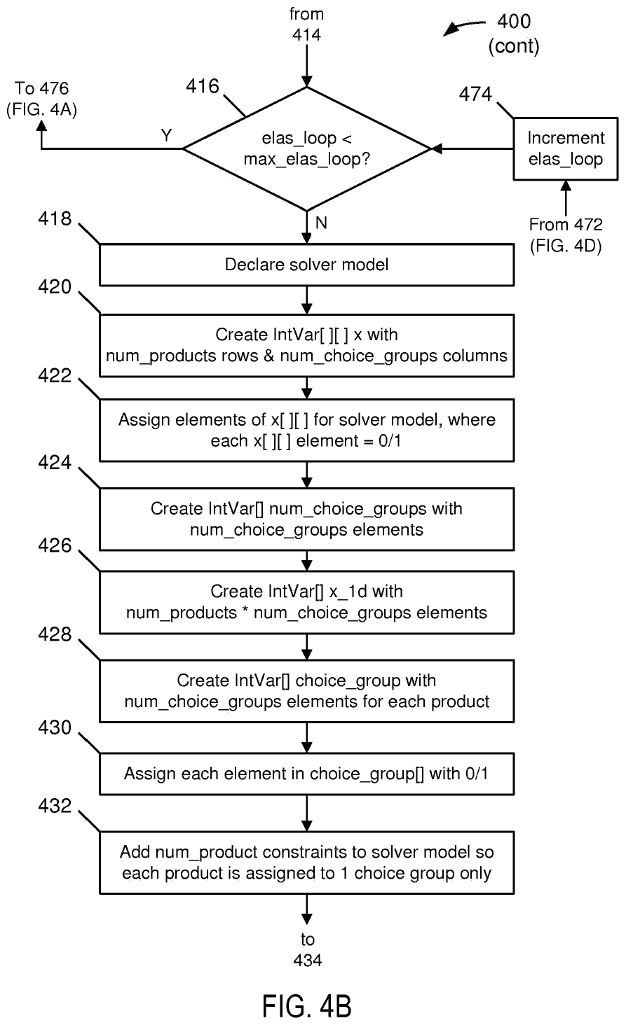

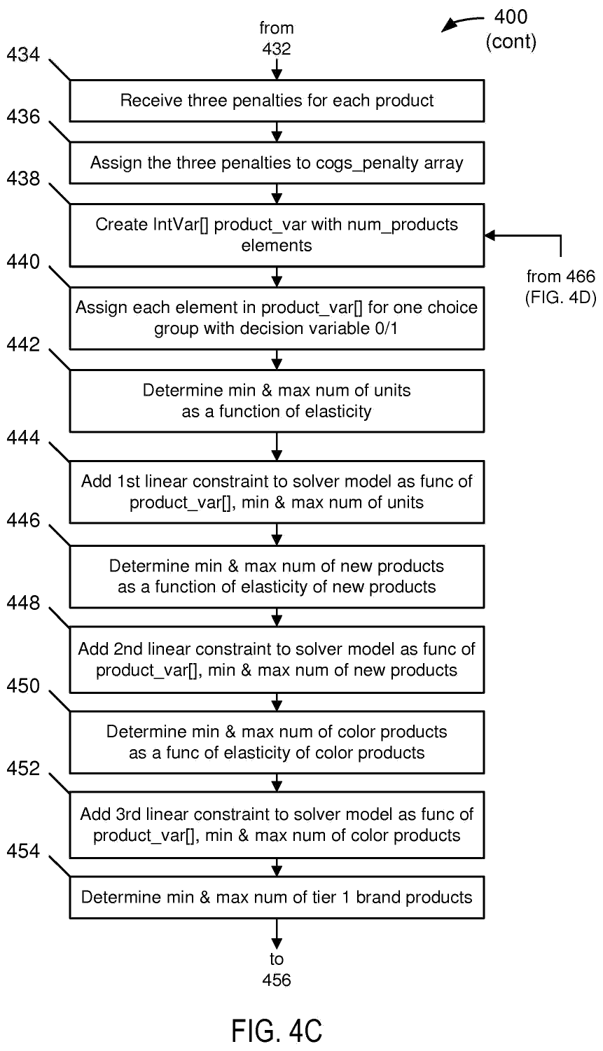

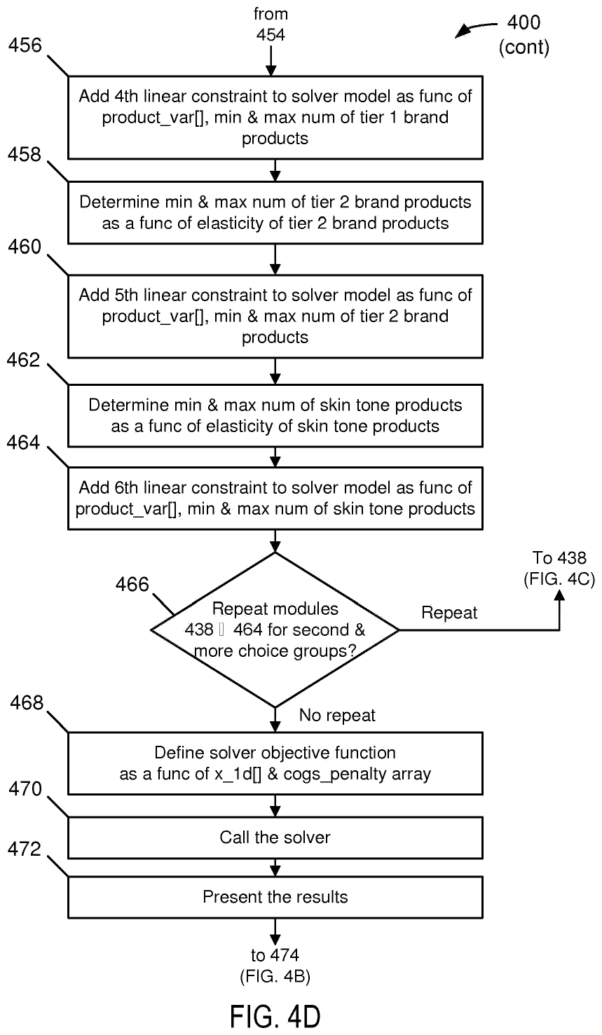

Referring now to FIG. 4, flowchart 400 is presented for disclosing an example of a method of a constraint-based allocation of materials embodied in the code.

Flowchart beings with module 402 with importing of libraries required by the solver. It should be noted that, although this illustrative example will be drawn to the constraint programming libraries provide in Google OR-Tools, the embodiments herein are not limited to the solver provided by these tools. Exemplary code for performing this module is shown in lines 102-116, inclusive.

Flowchart continues with module 404 with assigning of product parameters, percentiles of COGS of the products, and elasticities and iterations (i.e., loops). As will be shown below, elasticities will vary in value as they are iteratively employed to define lower and upper bounds of constraints of the total units, new units, color products, tiered products, and skin tones that will be added to a model as described below. Exemplary code for performing this module is shown in lines 120-186, inclusive.

Flowchart continues with module 406 with creating an outer loop of elasticity, i.e., a skin tone elasticity loop, of which the user has set a skin tone elasticity loop counter to 0 for the purpose of counting the number of times the outer loop is performed. In the illustrative example, the skin tone elasticity loop counter has been set equal to 2 as shown in line 180 of the exemplary code. This outer loop appears between lines 202-646, inclusive, of the exemplary code.

Flowchart continues with module 408 with determining a condition of whether the outer loop has reached its limit. In the illustrative example, the condition will be met when the skin tone elasticity loop has completed two iterations or cycles of the loop. If this condition has not been met, the flowchart proceeds to module 410; if the condition has been met; the flowchart proceeds to the end.

Flowchart continues with module 410 with creating a middle loop of elasticity, i.e., a new products elasticity loop, of which the user has set a new products elasticity loop counter to 0 for the purpose of counting the number of times the middle loop is performed. In the illustrative example, the new products elasticity loop counter has been set equal to 9 as shown in line 182 of the exemplary code. This middle loop appears between lines 206-644, inclusive, of the exemplary code.

Flowchart continues with module 412 with determining a condition of whether the middle loop has reached its limit. In the illustrative example, the condition will be met when the new products elasticity loop has completed nine iterations or cycles of the loop. If this condition has not been met, the flowchart proceeds to module 414; if the condition has been met; the flowchart proceeds to module 478 (where the skin tone elasticity loop counter will be incremented by 1 before the flowchart returns to module 408).

Flowchart continues with module 414 with creating an inner loop of elasticity, i.e., an elasticity loop, of which the user has set an elasticity loop counter to 0 for the purpose of counting the number of times the inner loop is performed. In the illustrative example, the elasticity loop counter has been set equal to 9 as shown in line 184 of the exemplary code. This inner loop appears between lines 210-642, inclusive, of the exemplary code.

Flowchart continues with module 416 with determining the condition of whether the inner loop has reached its limit. In the illustrative example, the condition will be met when the elasticity loop has completed nine iterations or cycles of the loop. If this condition has not been met, the flowchart proceeds to module 418; if the condition has been met; the flowchart proceeds to module 476 (where the new products elasticity loop counter will be incremented by 1 before the flowchart returns to module 412).

Given the three loop counters set by the user, the inner, middle, and outer loops will be performed 162 (9*9*2), 18 (9*2), and 2 times, respectively. For each inner loop, a solver objective function is defined as a function of a decision variable and a penalty array discussed in detail below; after solver objective function has been defined at the end of each iteration of the inner loop, the solver is called to provide those solutions that could be determined as optimal or feasible as discussed in detail below.

As each loop is being iterated, one or more elasticities are increased. When applied to constraints, the range between lower and upper boundaries defining the constraints expands with an increase of these one or more elasticities, thus increasing the solve space and reducing or eliminating the efforts exerted by manual crosschecking or adjusting of elasticities. By utilizing the elasticities as disclosed herein discussed, the likelihood that no solution is found is greatly reduced.

Flowchart continues with module 418 with declaring a solver model to which all of the constraints discussed below are applied. Because this is performed at the top of the inner loop, the model will be re-declared each time the inner loop is performed, regardless of whether optimal and feasible solutions are found at the ends of preceding iterations of the loop. Syntax for making the declaration appears in line 302 of the exemplary code.

Flowchart continues with module 420 with creating a two-dimensional decision variable IntVax[ ][ ] x as shown in line 402 of the exemplary code; the number of rows will equal the number of products (i.e., 12), and the number of columns will equal the number of choice groups (i.e., 3). Thus, IntVax[ ][ ] x will have 36 elements.

It should be noted that a decision variable such as IntVax[ ][ ] x is comprised of elements representative of unknowns that need to be found; that is, during the solving process performed by the solver, the constraint programming optimizer must assign each element a value from its domain in such a way that all specified constraints are satisfied.

Flowchart continues with module 422 with assigning a value for each element x[ ][ ] of IntVax[ ][ ] x. The two for-loops between lines 404-412, inclusive, of the exemplary code is used to assign each element of x[ ][ ] with a binary value of 0 or 1 during the solving process performed by the solver. At line 408, model.newIntVar is syntax in which the solver begins to build the model declared at line 302. As shown in FIG. 3A, each element x[i][j] has been assigned with 0 or 1.

Flowchart continues with module 424 with creating a one-dimensional decision variable IntVar[ ] num_choice_groups having a number of elements equal to the number of choice groups (i.e., 3). The creation of IntVar[ ] num_choice_groups appears in 420 of the exemplary code.

Flowchart continues with module 426 with creating a one-dimensional decision variable IntVar[ ] x_1d[ ] that having 36 elements as determined by the number of products multiplied by the number of choice groups. The creation of IntVar[ ] x_1d[ ] is shown in line 422 of the exemplary code, and an assignment of each element with 0 or 1 is shown in line 436 of the exemplary code, where 0 and 1 are the values of each element in x[ ][ ] (as shown in FIG. 3A). As shown in FIG. 3B, each element in x_1d[k] has been assigned with 0 or 1. As discussed below, x_1d[ ] will be used to define to a solver objective function in line 602 of the exemplary code discussed below.

Flowchart continues with module 428 with creating a one-dimensional decision variable IntVar[ ] choice_group having three elements. The creation of IntVar[ ] choice_group is shown in line 428 of the exemplary code. As shown, this line of code is nested between two for-loops. Because of this nesting, it will be created initially once and then recreated after constraints are added to the model at line 444. In the illustration example, it will be created initially and recreated 11 more times.

Flowchart continues with module 430 with assigning each element of choice_group[ ] with the value of 0 or 1 as shown in line 432 of the exemplary code, where 0 and 1 are the values of each element in x[ ][ ] (as shown in FIG. 3A). Because this occurs within the for-loop found between lines 430-442, inclusive, the three elements of choice_group[ ] will have values of 0 or 1 of x[ ][ ] (as shown in FIG. 3A) upon the completion of this for-loop. As shown in FIG. 3C, each element in choice_group[j] has been assigned with 0 or 1.

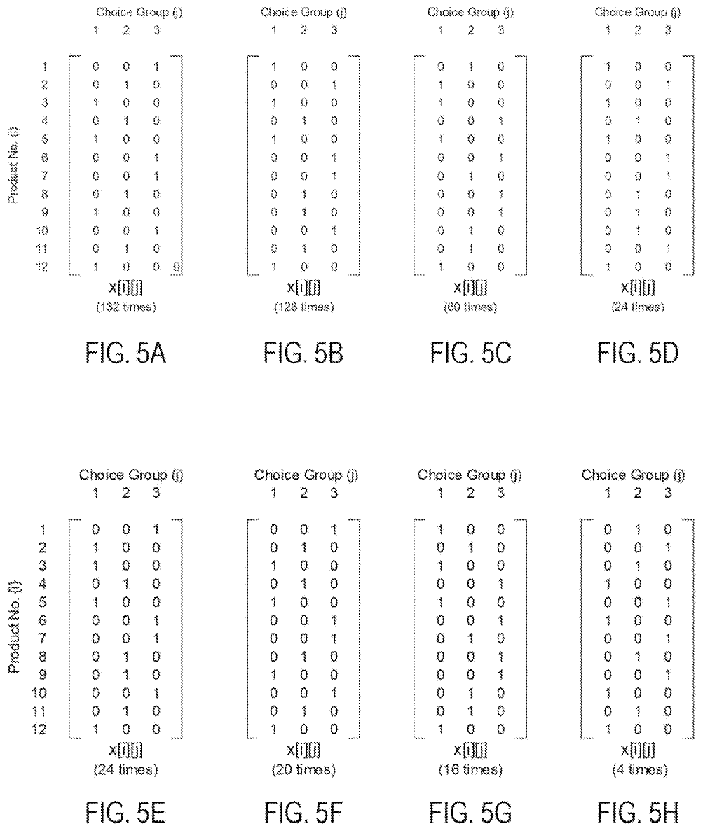

Flowchart continues with module 432 with adding a number of constraints to the model equal to the number of products, where the addition of each constraint — one at a time and nested between two loops—is reflected in the code at line 444 after each performance of the for-loop found between lines 430-442, inclusive. As indicated by syntax of the solver, the constraint will require the sum of the elements in the row—each having a binary value of 0 or 1—to be 1. Because line 444 of the code is nested between two for-loops and the number of iterations of the outer loop equals the number of times equal to the number of products as shown in line 426, a total of twelve constraints will be added to the model in the illustrative example. Each constraint corresponds to one of the 12 products, and each product will have two 0s and one 1. Examples that reflect the addition of this constraint to the model—the results of two 0s and one 1 for each product (or row)—are provided in FIGS. 5A-5H, inclusive.

Flowchart continues with module 434 with receiving three penalties for each product upon the return of the penalties from a penalty function. As shown in line 438 of the exemplary code, a penalty variable is returned after getting a penalty function in which the COGS for product number i and choice group j are provided to the penalty function along with the COGS parameters for 30th, 70th, and 100th percentile assigned in module 404. Because line 438 appears within the for-loop found between lines 430-442, inclusive, and for-loop found between lines 426-446, inclusive, a total of 36 penalties will be returned for the 12 products of the illustrative example. Although the solver will find a solution for which each product will be assigned to one choice group, it will be assumed for the purpose of being assigned a penalty that each product belongs to each choice group.

The penalty function shown in lines 700-746, inclusive. As observed, there is a switch statement in line 704 to evaluate the expression “block” by selecting one of the three code blocks defined as Case 0, Case 1, and Case 2 to be executed. Case 0 corresponds to choice group 1, Case 1 corresponds to choice group 2, and Case 2 corresponds to choice group 3.

From the previous discussion, it was assumed that a vendor wanted the “high cost” items such as those with relatively high COGS to be placed into Choice Group 1 (those COGS above the 70th percentile); the “low cost” items such as those with relatively low COGS to be placed into Choice Group 3 (those COGS less than or equal to the 30th percentile; and those items that are neither “high cost” or “low cost” to be placed into Choice Group 2 (those COGS greater the 30th percentile but less than or equal to the 70th percentile).

A product with a COGS greater than the 70th percentile will receive penalties of 1, 16, and 32 when subjected to examination under Cases 0, 1, and 2, respectively. Because of its high COGS, the vendor would like for it to be placed into choice group 1; as such, it will receive the minimal penalty of 1. Similarity, the vendor would like to avoid its placement in choice 3, hence, product will receive a maximum penalty of 32; however, when other constraints are applied, it may be necessary to please the product in a choice group other than choice group 1. In such a case, the product will receive a penalty of 16 which is above the minimum penalty and below the maximum penalty.

A product with a COGS less than or equal to the 30th percentile will receive penalties of 32, 16, and 1 when subjected to examination under Cases 0, 1, and 2, respectively. Because of its low COGS, the vendor would like for it to be placed into choice group 3; as such, it will receive the minimal penalty of 1. Similarity, the vendor would like to avoid its placement in choice 1, hence, product will receive a maximum penalty of 32; however, when other constraints are applied, it may be necessary to please the product in a choice group other than choice group 3. In such a case, the product will receive a penalty of 16 which is above the minimum penalty and below the maximum penalty.

A product with a COGS greater than the 30th percentile and less than or equal to the 70th percentile will receive penalties of 16, 1, and 16 when subjected to examination under Cases 0, 1, and 2, respectively. Here, it is unknown whether the product might end up in choice group 1 or choice group 3, hence, product will receive a penalty of 16 for choice group 1 and choice group 3.

For example, Product No. 1 has a COGS of $4.35. Because it is greater than 30th percentile of $3.54 and less than or equal to the 70th percentile of $5.13, it will be assigned penalties of 16, 1, and 16 for Cases 0, 1, and 2, respectively.

Similarly, Product No. 2 has a COGS of $2.10 which is less than the 30th percentile of $3.54; as such it will be assigned penalties of 32, 16, and 1 for Cases 0, 1, and 2, respectively.

Likewise, Product No. 3 has a COGS of $6.00. Because it is greater than the 70th percentile of $5.13, it will be assigned penalties of 1, 16, and 32 for Cases 0, 1, and 2, respectively.

Flowchart continues with module 436 with assigning the three penalties for each product to a penalty[ ] array created in line 424 of the exemplary code as the penalties are returned from the penalty function; as shown in FIG. 3D, the penalty array has been with a number of elements equal to the product of the number of products and number of choice groups (i.e., 36).

When the penalty is returned each time to line 438 of the exemplary code, it will be assigned to an element of cogs_penalty[ ] array as shown in line 440 of the exemplary code; the penalty's position within the array is dependent upon both the product number and choice group number.

As applied, the penalties returned from the penalty function will be

assigned to the cogs_penalty[ ] array in a left-to-right sequence. The first three elements in the array (positions 0-2, inclusive) will correspond to the three penalties assigned to the first product (e.g., Product No. 1 are 16, 1, and 16), the next three elements in the array (positions 3-5, inclusive) will correspond to the three penalties assigned to the second product (e.g., Product No. 2 are 32, 16, and 1), and so forth until the last three elements in the array (positions 33-35, inclusive) correspond to the three penalties assigned to the twelfth product (e.g., Product No. 12 are 1, 16, and 32).

Referring to FIG. 3E, the penalties of the 12 products are shown in the cogs_penalty[ ] array which, along with IntVar[ ] x_1d[ ], will be used in defining the solver objective function. As discussed below, cogs_penalty[ ] will be used to define to the solver objective function in line 602 of the exemplary code discussed below.

Flowchart continues with module 438 with creating a one-dimensional decision variable IntVar[ ] product_var[ ] having a number of elements equal to the number of products (i.e., 12). The creation of IntVar[ ] product_var[ ] appears in line 452 of the exemplary code. As shown, it is nested between a for-loop found between lines 450 and 516, inclusive, and a for-loop found between lines 454 and 458, inclusive, and will be performed a number of times equal to the number of choice groups (i.e., 3).

Flowchart continues with module 440 with assigning each element of product_var[ ] with the value of 0 or 1 as shown in line 456 of the exemplary code. Because this occurs within the for-loop found between lines 454-458, inclusive, the three elements of product_var[ ] will have values of 0 or 1 of x[ ][ ] (as shown in FIG. 3A) upon the completion of this for-loop. As shown in FIG. 3F, each element in product_var[j] has been assigned with 0 or 1.

Flowchart continues with module 442 with determining minimum number and maximum number of units as a function of the elasticity of all products and mean number of units as defined at lines 178 and 132, respectively,

Flowchart continues with module 444 with adding a first linear constraint to the model for each product of the twelve products. As indicated by the solver syntax at line 464 of the exemplary code, the first linear constraint is defined as function of the product_var[ ], the product units of line 126, and the minimum number and maximum number of units defining the lower and upper bounds, respectively. Because the addition is found within the loop found between lines 454-458, inclusive, the first linear constraint for each product will be added a total of three times, once for each choice group.

Flowchart continues with module 446 with determining minimum number and maximum number of new units as a function of the elasticity of new products and mean number of new units as defined at lines 176 and 136, respectively.

Flowchart continues with module 448 with adding a second linear constraint to the model for each product of the twelve products, where this constraint is added to the mod& so that there is an even allocation of new products across the three choice groups by ensuring the sum of the new units fall within the lower and upper bounds defined by the minimum number and maximum number of new units. As indicated by the solver syntax at fine 474 of the exemplary code, the second Hear constraint is defined as function of the product_var[ ], the twelve new product flags defined in line 138, and the minimum number and maximum number of new units. Because the addition is found within the loop found between lines 454-458, inclusive, the second linear constraint for each product will be added a total of three times, once for each choice group.

Flowchart continues with module 450 with determining minimum number and maximum number of color products as a function of the elasticity of color products and mean number of color products as defined at lines 174 and 142, respectively.

Flowchart continues with module 452 with adding a third linear constraint to the model for each product of the twelve products, where this constraint is added to the model so that the number of color products are equally distributed across the three choice groups and fall within the lower and upper bounds defined by the minimum number and maximum number of color products. As indicated by the solver syntax at line 486 of the exemplary code, the third linear constraint is defined as function of the product_var[ ], the twelve color product flags defined in line 144 of the code, and the minimum number and maximum number of color products. Because the addition is found within the loop found between lines 454-458, inclusive, the third linear constraint for each product will be added a total of three times, once for each choice group.

Flowchart continues with module 454 with determining minim urn number and maximum number of tier 1 brand products as a function of the mean of tier 1 brand products as defined at line 148.

Flowchart continues with module 456 with adding a fourth linear constraint to the model for each product of the twelve products, where this constraint is added to the model so that tier 1 brands are equally distributed across the three choice groups. As indicated by the solver syntax at line 494 of the exemplary code, the fourth linear constraint is defined as function of the product-var[ ], the twelve tier 1 product flags defined in line 150 of the code, and the minimum number and maximum number of tier 1 brand. Because the addition is found within the loop found between lines 454-458, inclusive, the fourth linear constraint for each product will be added a total of three times, once for each choice group.

Flowchart continues with module 458 with determining minimum number and maximum number of tier 2 brand products as a function the elasticity of tier 2 brand products and mean of tier 2 brand products as defined at line 172 and 154. respectively.

Flowchart continues with module 460 with adding a fifth linear constraint to the model for each product of the twelve products, where this constraint is added to the model so that tier 2 brands are equally distributed across the three choice groups. As indicated by the solver syntax at line 504 of the exemplary code, the fifth linear constraint is defined as function of the product_var[ ], the twelve tier 2 product flags defined in line 156 of the code and the minimum number and maximum number of tier 2 brands. Because the addition is found within the loop found between lines 454-458, inclusive, the fifth linear constraint for each product will be added a total of three times, once for each choice group.

Flowchart continues with module 462 with determining minimum number and maximum number of skin tone products as a function of the elasticity of skin tone products and mean number of skin tones as defined at lines 170 and 160, respectively.

Flowchart continues with module 464 with adding a sixth linear constraint to the model for each product of the twelve products, where this constraint is added to the model so that skin tones are equally distributed across the three choice groups. As indicated by the solver syntax at line 514 of the exemplary code, the sixth linear constraint is defined as function of the product_var[ ], the twelve color skin tone product flags defined in line 162 of the code and the minimum number and maximum number of skin tones. Because the addition is found within the loop found between lines 454-458, inclusive, the sixth linear constraint for each product will be added a total of three times, once for each choice group.

Flowchart continues with module 466 with repeating modules 438-464, inclusive, for second and subsequent choice groups until these modules have been performed for each choice group; each iteration of the for-loop between lines 450-516, inclusive, performs these modules until a number of iterations equal to the number of choice groups (i.e., 3) as set in line 450 of the exemplary code. If modules 438-464 have not been performed for each choice group, then the six linear constraints have not been added to each individual product across all of the choice groups; as such, the flowchart returns to module 438 and repeats modules 438-464, inclusive until the six linear constraints are added to each individual product across all of the choice groups.

Flowchart continues with module 468 with the defining of the solver objective function of the model. The purpose of this is to minimize the global penalty of the product allocation to the choice groups. As indicated by the solver syntax at line 602 of the exemplary code, the solver declares the objective to be a minimization function as a function of a linear expression defined by x_1d[ ] created in module 426 and the penalties in the cogs_penalty array that were assigned in module 436. In the illustrative example, the solver objective function is defined after the 6 linear constraints have been added a total of thirty-six times, the number of products multiplied by the number of choice groups.

Flowchart continues with module 470 with the calling of the solver as indicated by the solver syntax at lines 612-614 of the exemplary code. The solver represents the main computation engine solving the problem defined by the model.

Flowchart continues with module 472 with presenting the results including one or more status values from solver and solver value of x[ ][ ]. In one embodiment, Google Solver provides five status values: OPTIMAL, FEASIBLE, INFEASIBLE, MODEL_INVALID, and UNKNOWN. Of these five, OPTIMAL indicates the finding of an optimal solution, and FEASIBLE indicates a feasible solution was found, but it is unknown of whether the solution is optimal; as such, individual users may then investigate the feasible solution for possible alternative solutions. For the optimal and feasible solutions, Solver could present the values of x[ ][ ] which meet all or most of the constraints that were added to the model as reflected in lines 622-634, inclusive.

Flowchart continues with module 474 with incrementing the inner loop of elasticity and returning to module 416 so that the decision of whether the solver has completed the defined number of inner loops within the middle and outer loops of new product elasticity and skin tone elasticity, respectively. If completed, the flowchart proceeds to module 476. If not completed, the solver will continue finding solutions by increasing the elasticity for each cycle of the inner loop of modules 418-472, inclusive. By doing so, the difference between the minimum and maximum number of units of module 442 increases, thereby expanding the number of units added to the first linear constraint. This expanded range enables the solver with the ability to consider more units and increasing the likelihood of more optimal and feasible solutions.

If the flowchart proceeds to module 476 from module 416, the middle loop of new product elasticity is incremented, and the flowchart returns to module 412 so that the decision of whether the solver has completed the defined number of middle loops within the outer loop of skin tone elasticity. If completed, the flowchart proceeds to module 478. If not completed, the flowchart proceeds to module 414 so that the solver will continue finding solutions by increasing the elasticity of new units for each cycle of the inner loop of modules 418-470, inclusive. By doing so, the difference between the minimum and maximum number of new units of module 446 increases, thereby expanding the number of new units added to the second linear constraint. This expanded range enables the solver with the ability to consider more new units and increasing the likelihood of more optimal and feasible solutions.

If the flowchart proceeds to module 478 from module 412, the outer loop of skin tone elasticity is incremented, and the flowchart returns to module 408 so that the decision of whether the solver has completed the defined number of outer loops of skin tone elasticity. If not completed, the flowchart proceeds to module 410 so that the solver will continue finding solutions by increasing the skin tone elasticity for each cycle of the inner loop of modules 418-470, inclusive. By doing so, the difference between the minimum and maximum number of skin tone products of module 462 increases, thereby expanding the number of skin tone products added to the sixth linear constraint. This expanded range enables the solver with the ability to consider more skin tone products and increasing the likelihood of more optimal and feasible solutions.

If the solver has completed the defined number of outer loops of skin tone elasticity as determined in module 408, the flowchart proceeds to the end.

Referring now to FIGS. 5A-5H, eight results of decision variable x[ ][ ] produced from the exemplary code of FIGS. 2A-2E using the data in FIG. 1 are presented. In fact, there were a total of 408 optimal or feasible solutions determined by the solver from the data; as observed, however, all of the results have been repeated. The results of FIGS. 5A-5H have been repeated 132, 128, 60, 24, 24, 20, 16, and 4 times, respectively.

The application of two constraints to the model are apparent by reviewing these eight results. For instance, all entries are either 0 or 1 as assigned as a constraint for the model in module 422. Also, the sum of the three elements in each row to be is 1, ensuring that one element in each row is 1. In some embodiments, each product will be assigned in the choice group corresponding to the value 1.

As shown in FIG. 5A, the solver has determined 132 times that one of the optimal or feasible solutions includes the assignments of Product Nos 3, 5, 9, and 12 to Choice Group 1; Product Nos. 2, 4, 8, and 11 to Choice Group 2; and Product Nos. 1, 6, 7, and 10 to Choice Group 3.

As shown FIG. 5B, solver has determined 128 times that one of the optimal or feasible solutions includes the assignments of Product Nos 1, 3, 5, and 12 to Choice Group 1; Product Nos. 4, 8, 9, and 11 to Choice Group 2; and Product Nos. 2, 6, 7, and 10 to Choice Group 3.

As shown FIG. 5C, solver has determined 60 times that one of the optimal or feasible solutions includes the assignments of Product Nos 2, 3, 5, and 12 to Choice Group 1; Product Nos. 1, 7, 10, and 11 to Choice Group 2; and Product Nos. 4, 6, 8, and 9 to Choice Group 3.

As shown FIG. 5D, solver has determined 24 times that one of the optimal or feasible solutions includes the assignments of Product Nos 1, 3, 5, and 12 to Choice Group 1; Product Nos. 4, 8, 9, and 10 to Choice Group 2; and Product Nos. 2, 6, 7, and 11 to Choice Group 3.

As shown FIG. 5E, solver has determined 24 times that one of the optimal or feasible solutions includes the assignments of Product Nos 2, 3, 5, and 12 to Choice Group 1; Product Nos. 4, 8, 9, and 11 to Choice Group 2; and Product Nos. 1, 6, 7, and to Choice Group 3.

As shown FIG. 5F, solver has determined 20 times that one of the optimal or feasible solutions includes the assignments of Product Nos 3, 5, 9, and 12 to Choice Group 1; Product Nos. 2, 4, 8, and 11 to Choice Group 2; and Product Nos. 1, 6, 7, and to Choice Group 3.

As shown FIG. 5G, solver has determined 16 times that one of the optimal or feasible solutions includes the assignments of Product Nos 1, 3, 5, and 12 to Choice Group 1; Product Nos. 2, 7, 10, and 11 to Choice Group 2; and Product Nos. 1, 4, 6, 8, and 9 to Choice Group 3.

As shown FIG. 5G, solver has determined 16 times that one of the optimal or feasible solutions includes the assignments of Product Nos 4, 6, 10, and 12 to Choice Group 1; Product Nos. 1, 3, 8, and 11 to Choice Group 2; and Product Nos. 2, 5, 7, and 9 to Choice Group 3.

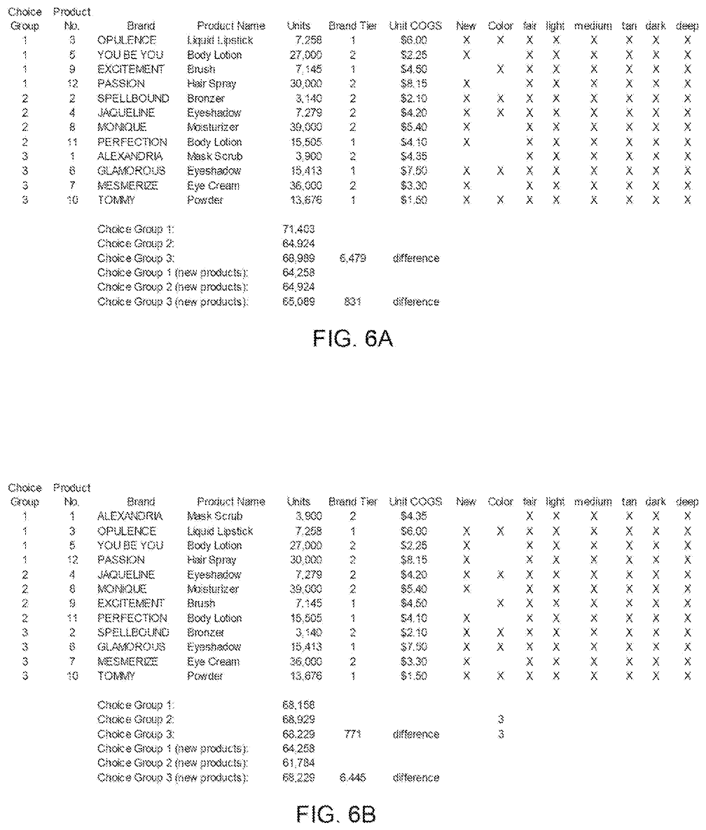

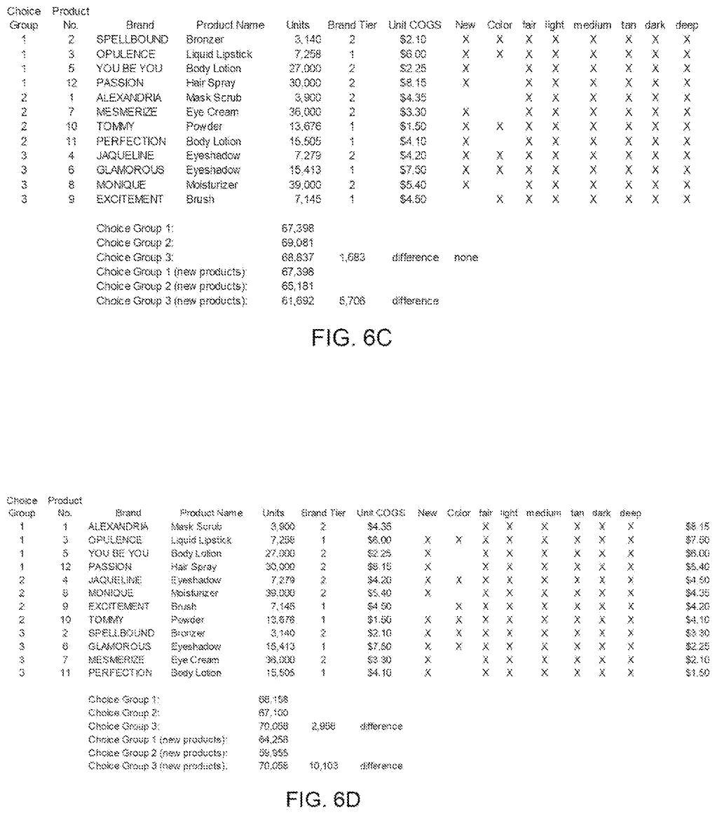

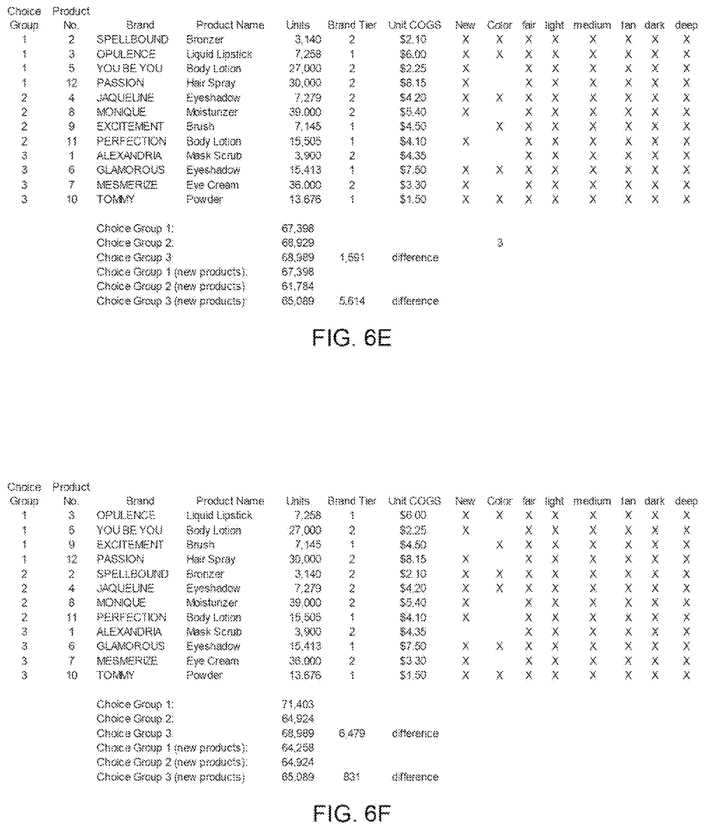

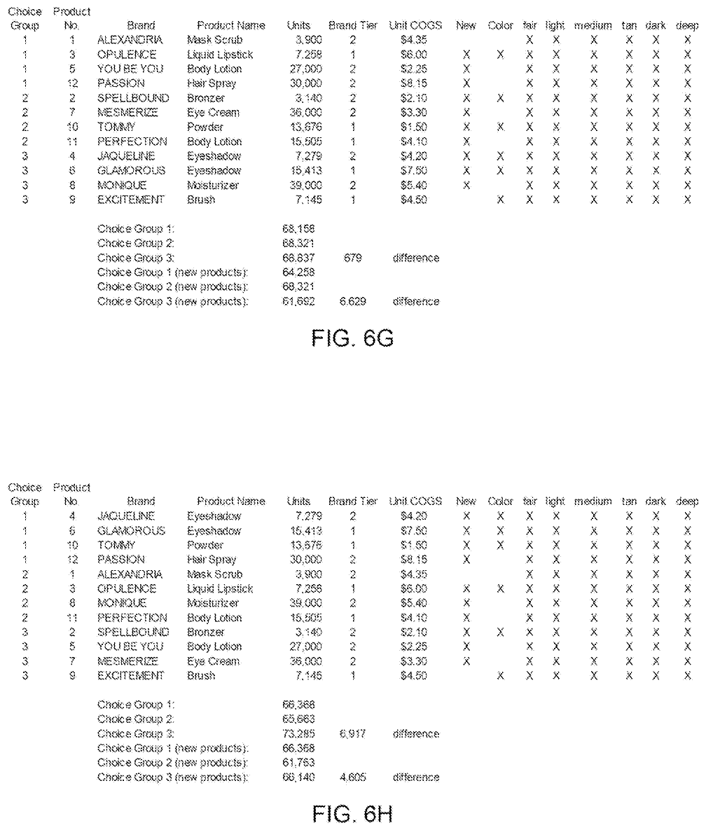

Referring now to FIGS. 6A-6H, the eight results produced in FIGS. 5A-5H, respectively, are presented with the identification of product information and their allocation across the three choice groups. An examination of these will illustrate that there is not one solution which fits all of the criteria set forth by the vendor and as defined by the constraints. Regardless, solver determined the status of the following as either optimal or feasible solutions from which a user may examine and choose:

As shown FIG. 6A, the difference of units between the three choice groups of 6,479 is relatively high when compared to FIGS. 6B and 6G; on the other hand, the difference of new units between the three choice groups of 831 is relatively low when compared to all others except for FIG. 6F. Here, it appears that the constraint in which the number of units be balanced across the choice groups was not met, but that the constraint in which the number of new units be was met.

With respect to Unit COGS, the sequence should ideally be the following: $8.15, $7.50, $6.00, and $5.40 for Choice Group 3; $4.50, $4.35, $4.20, and $4.10 for Choice Group 2; and $3.30, $2.25, $2.10, and $1.50 for Choice Group 1. Here, the constraint corresponding to COGS was not met as Product Nos. 6 and 8 did not fall into Choice Group No. 3, Product Nos. 1 and 11 did not fall into Choice Group 2, and Product Nos. 5 and 10 did not fall into Choice Group 1.

New products met the constraint as they were balanced where 3, 3, and 4 fell within Choice Groups 3, 2, and 1, respectively; brand tiers constraints were met where brand tier 1 was balanced 2, 2, and 1 within Choice Groups 3, 2, and 1, respectively; and the color products met the constraint as they were balanced because 2 color products fell into Choice Groups 1, 2 and 3 each.

As shown FIG. 6B, the difference of units between the three choice groups of 771 is relatively low; on the other hand, the difference of new units between the three choice groups of 6,445 is relatively high. Here, it appears that the constraint in which the number of units be balanced across the choice groups was met, but that the constraint in which the number of new units be balanced across the choice groups was not met.

With respect to Unit COGS, the constraint corresponding to COGS was met as only four products did not fall into their ideal choice groups: Product Nos. 6 and 8 did not fall into Choice Group No. 3, Product No. 1 did not fall into Choice Group 2, and Product No. 5 did not fall into Choice Group 1.

New products met the constraint as they were balanced where 3, 3, and 4 fell within Choice Groups 3, 2, and 1, respectively; also, the brand tiers constraints were met where brand tier 1 was balanced 1, 2, and 2 within Choice Groups 3, 2, and 1, respectively; however, the color products did not meet the constraint as they were not balanced because only 1 color product fell into Choice Group 3, but 3 color products fell into Choice Group 1.

As shown FIG. 6C, the difference of units between the three choice groups of 1,683 is modest; on the other hand, the difference of new units between the three choice groups of 5,706 is relatively high. Here, it appears that the constraint in which the number of units be balanced across the choice groups was met, but that the constraint in which the number of new units be balanced across the choice groups was not met.

With respect to Unit COGS, the constraint corresponding to COGS was not met as six products did not fall into their ideal choice groups: Product Nos. 6 and 8 did not fall into Choice Group No. 3, Product Nos. 4 and 9 did not fall into Choice Group 2, and Product Nos. 1 and 11 did not fall into Choice Group 1.

New products met the constraint as they were balanced where 4, 3, and 3 fell within Choice Groups 3, 2, and 1, respectively; brand tiers constraints were met where brand tier 1 was balanced 1 2, and 2 within Choice Groups 3, 2, and 1, respectively; however, the color products did not meet the constraint as they were not balanced because only 1 color product fell into Choice Group 2, but 3 color products fell into Choice Group 1.

As shown FIG. 6D, the difference of units between the three choice groups of 2,958 is relatively high, and the difference of new units between the three choice groups of 10,103 is extremely high. Here, it the constraint in which the number of units be balanced across the choice groups was not met, and that the constraint in which the number of new units be balanced across the choice groups was severely not met.

With respect to Unit COGS, the constraint corresponding to COGS was not met as six products did not fall into their ideal choice groups: Product Nos. 6 and 8 did not fall into Choice Group No. 3, Product Nos. 1 and 11 did not fall into Choice Group 2, and Product Nos. 5 and 10 did not fall into Choice Group 1.

New products met the constraint as they were balanced where 3, 3, and 4 fell within Choice Groups 3, 2, and 1, respectively; brand tiers constraints were met where brand tier 1 was balanced 1, 2, and 2 within Choice Groups 3, 2, and 1, respectively; however, the color products did not meet the constraint as they were not balanced because only 1 color product fell into Choice Group 3, but 3 color products fell into Choice Group 2.

As shown FIG. 6E, the difference of units between the three choice groups of 1,591 is relatively modest, but the difference of new units between the three choice groups of 5,614 is relatively high. Here, the constraint in which the number of units be balanced across the choice groups was met, but that the constraint in which the number of new units be balanced across the choice groups was not met.

With respect to Unit COGS, the constraint corresponding to COGS was not met as five products did not fall into their ideal choice groups: Product Nos. 6 and 8 did not fall into Choice Group No. 3, Product No. 1 did not fall into Choice Group 2, and Product Nos. 2 and 5 did not fall into Choice Group 1.

New products met the constraint as they were balanced where 4, 3, and 3 fell within Choice Groups 3, 2, and 1, respectively; also, brand tiers constraints were met where brand tier 1 was balanced 1, 2, and 2 within Choice Groups 3, 2, and 1, respectively; also, the color products met the constraint as they were balanced because 2 color products fell into Choice Groups 1, 2 and 3 each.

As shown FIG. 6F, the difference of units between the three choice groups of 6,479 is relatively high, but the difference of new units between the three choice groups of 831 is relatively low. Here, the constraint in which the number of units be balanced across the choice groups was not met, but that the constraint in which the number of new units be balanced across the choice groups was met.

With respect to Unit COGS, the constraint corresponding to COGS was not met as five products did not fall into their ideal choice groups: Product Nos. 6 and 8 did not fall into Choice Group No. 3, Product Nos. 1 and 9 did not fall into Choice Group 2, and Product Nos. 2 and 5 did not fall into Choice Group 1.

New products met the constraint as they were balanced where 3, 4, and 3 fell within Choice Groups 3, 2, and 1, respectively; also, brand tiers constraints were met where brand tier 1 was balanced 2, 1, and 2 within Choice Groups 3, 2, and 1, respectively; also, the color products met the constraint as they were balanced because 2 color products fell into Choice Groups 1, 2 and 3 each.

As shown FIG. 6G, the difference of units between the three choice groups of 679 is relatively low, but the difference of new units between the three choice groups of 6,629 is relatively high. Here, the constraint in which the number of units be balanced across the choice groups was met, but that the constraint in which the number of new units be balanced across the choice groups was not met.

With respect to Unit COGS, the constraint corresponding to COGS was not met as nine products did not fall into their ideal choice groups: Product Nos. 6 and 8 did not fall into Choice Group No. 3, Product Nos. 1, 4, and 9 did not fall into Choice Group 2, and Product Nos. 2, 5, 7, and 10 did not fall into Choice Group 1.

New products met the constraint as they were balanced where 3, 4, and 3 fell within Choice Groups 3, 2, and 1, respectively; also, brand tiers constraints were met where brand tier 1 was balanced 1, 2, and 2 within Choice Groups 3, 2, and 1, respectively; however, the color products did not meet the constraint as they were not balanced because only 1 color product fell into Choice Group 3, but 3 color products fell into Choice Group 1.

As shown FIG. 6H, the difference of units between the three choice groups of 6,971 is relatively high, and the difference of new units between the three choice groups of 4,605 is relatively high. Here, the constraint in which the number of units be balanced across the choice groups was not met, but that the constraint in which the number of new units be balanced across the choice groups was not met.

With respect to Unit COGS, the constraint corresponding to COGS was not met as five products did not fall into their ideal choice groups: Product Nos. 3 and 8 did not fall into Choice Group No. 3, Product Nos. 4 and 9 did not fall into Choice Group 2, and Product No. 10 did not fall into Choice Group 1.

New products met the constraint as they were balanced where 4, 3, and 3 fell within Choice Groups 3, 2, and 1, respectively; also, brand tiers constraints were met where brand tier 1 was balanced 2, 2, and 1 within Choice Groups 3, 2, and 1, respectively; however, the color products did not meet the constraint as they were not balanced because 3 color products fell into Choice Group 3, but 1 color product fell into Choice Group 2.

As these results indicate, there is no one perfect solution; rather, there is an optimization of products as a function of the constraints applied to a model to meet an objective.

It should be noted that the steps of the method described above may be embodied in computer-readable media stored in a non-transitory computer-readable medium as computer instruction code. The method may include one or more of the steps described herein, which one or more steps may be carried out in any desired order including being carried out simultaneously with one another. For example, two or more of the steps disclosed herein may be combined in a single step and/or one or more of the steps may be carried out as two or more sub-steps. Further, steps not expressly disclosed or inherently present herein may be interspersed with or added to the steps described herein, or may be substituted for one or more of the steps described herein as will be appreciated by a person of ordinary skill in the art having the benefit of the instant disclosure.

As used herein, the term “embodiment” means an embodiment that serves to illustrate by way of example but not limitation.

It will be appreciated to those skilled in the art that the preceding examples and embodiments are exemplary and not limiting to the broad scope of the inventive concepts disclosed herein. It is intended that all modifications, permutations, enhancements, equivalents, and improvements thereto that are apparent to those skilled in the art upon a reading of the specification and a study of the drawings are included within the broad scope of the inventive concepts disclosed herein. It is therefore intended that the following appended claims include all such modifications, permutations, enhancements, equivalents, and improvements falling within the broad scope of the inventive concepts disclosed herein.

What is claimed is:

1. A constraint-based method for allocating products performed by at least one processor unit(s) coupled to a non-transitory processor-readable medium(s) storing exemplary, processor-executable code, comprising:
importing libraries of a solver;
receiving data representative of a plurality of products with a number of products and a plurality of choice groups with a number of choice groups, where
each product of the plurality of products comprises a record with a plurality of fields of product characteristics including a first field comprising a number of units of the product and a second field comprising a cost of goods sold (COGS) of the product;
declaring a model for an allocation of the plurality of products to the plurality of choice groups;
determining a plurality of penalty values for each product as a function of the product's COGS and a plurality of percentile values determined from all of the second fields of the plurality of products;
defining a solver objective function as a minimizing function of a decision variable comprising a plurality of binary values and the plurality of penalty values for each product to minimize a global penalty of product allocation to the plurality of choice groups, where
the solver objective function is applied for the model constructed from a plurality of constraints determined from the plurality of fields for the plurality of products; and
calling the solver, such that
a plurality of status values for the allocation is returned, whereby each status value of the plurality of status values indicates to a user whether the model produces an optimal or feasible allocation of products as determined by the solver, and
each product is assigned to one of the choice groups.

2. The constraint-based method of claim 1, wherein a lowest penalty value and a highest penalty value of the plurality of penalty values are determined for each product.

3. The constraint-based method of claim 2, wherein the lowest penalty value and the highest penalty value are determined from the plurality of percentile values.

4. The constraint-based method of claim 1, wherein each penalty value of the plurality of penalty values for each product corresponds to one choice group of the plurality of choice groups.

5. The constraint-based method of claim 1, further comprising:
creating a plurality of loops prior to the model being declared, where
a first loop is defined to perform a number of first iterations in which a first elasticity of a plurality of elasticities is increased with each first iteration, where
the data is further representative of the plurality of elasticities,
a second loop is nested within the first loop and defined to perform a number of second iterations in which a second elasticity of the plurality of elasticities is increased with each second iteration, and
a third loop is nested within the second loop and defined to perform a number of third iterations in which a third elasticity of the plurality of elasticities is increased with each third iteration.

6. The constraint-based method of claim 5, further comprising:
creating a plurality of constraint-based loops after the model is declared, where
a first constraint-based loop is nested within the third loop and defined to perform a number of iterations equal to the number of choice groups, and
a second constraint-based loop is nested within the first constraint-based loop and defined to perform a number of iterations equal to the number of products, wherein
a plurality of constraints is added to the model for one product of the plurality of products with each iteration of the first loop, where
a first constraint is determined as a function of the first elasticity,
a second constraint is determined as a function of the second elasticity, and
a third constraint is determined as a function of the third elasticity;

7. The constraint-based method of claim 6, wherein
lower and upper bounds of the first constraint of the plurality of constraints decrease and increase, respectively, with each iteration of the first loop,
lower and upper bounds of the second constraint of the plurality of constraints decrease and increase, respectively, with each iteration of the second loop, and
lower and upper bounds of the third constraint of the plurality of constraints decrease and increase, respectively, with each iteration of the third loop.

8. A constraint-based method for allocating products performed by at least one processor unit(s) coupled to a non-transitory processor-readable medium(s) storing exemplary, processor-executable code, comprising:
importing libraries of a solver;
receiving data representative of a plurality of products with a number of products, a plurality of choice groups with a number of choice groups, and a plurality of elasticities, where
each product of the plurality of products comprises a record with a plurality of fields of product characteristics including a first field comprising a number of units of the product and a second field comprising a cost of goods sold (COGS) of the product;
creating a plurality of loops, where
a first loop is defined to perform a number of first iterations in which a first elasticity of the plurality of elasticities is increased with each first iteration,
a second loop is nested within the first loop and defined to perform a number of second iterations in which a second elasticity of the plurality of elasticities is increased with each second iteration, and
a third loop is nested within the second loop and defined to perform a number of third iterations in which a third elasticity of the plurality of elasticities is increased with each third iteration;
declaring a model for an allocation of the plurality of products to the plurality of choice groups in the third loop with each third iteration;
creating a plurality of constraint-based loops, where
a first constraint-based loop is nested within the third loop and defined to perform a number of iterations equal to the number of choice groups, and
a second constraint-based loop is nested within the first constraint-based loop and defined to perform a number of iterations equal to the number of products, wherein
a plurality of constraints is added to the model for one product of the plurality of products with each iteration of the first loop, where
a first constraint is determined as a function of the first elasticity,
a second constraint is determined as a function of the second elasticity, and
a third constraint is determined as a function of the third elasticity;
defining a solver objective function as a minimizing function of a decision variable comprising a plurality of binary values and a plurality of COGS-based penalty values for each product to minimize a global penalty of product allocation to the plurality of choice groups, where
the solver objective function is applied for the model constructed from a plurality of constraints determined from the plurality of fields for the plurality of products; and
calling the solver prior to the completion of each third iteration of the third loop, such that
a plurality of status values for the allocation is returned, whereby
each status value of the plurality of status values indicates to a user whether the model produces an optimal or feasible allocation of products as determined by the solver, and
each product is assigned to one of the choice groups.

9. The constraint-based method of claim 8, wherein
lower and upper bounds of the first constraint of the plurality of constraints decrease and increase, respectively, with each iteration of the first loop,
lower and upper bounds of the second constraint of the plurality of constraints decrease and increase, respectively, with each iteration of the second loop, and
lower and upper bounds of the third constraint of the plurality of constraints decrease and increase, respectively, with each iteration of the third loop.

10. The constraint-based method of claim 8, further comprising:
determining the plurality of COGS-based penalty values for each product as a function of the product's COGS and a plurality of percentile values determined from all of the second fields of the plurality of products.

11. The constraint-based method of claim 10, wherein a lowest penalty value and a highest penalty value of the plurality of COGS-based penalty values are determined for each product.

12. The constraint-based method of claim 11, wherein the lowest penalty value and the highest penalty value are determined from the plurality of percentile values.

13. The constraint-based method of claim 8, wherein each penalty value of the plurality of COGS-based penalty values for each product corresponds to one choice group of the plurality of choice groups.

14. A constraint-based method for allocating products performed by at least one processor unit(s) coupled to a non-transitory processor-readable medium(s) storing exemplary, processor-executable code, comprising:
importing libraries of a solver;
receiving data representative of a plurality of products with a number of products and a
plurality of choice groups with a number of choice groups, where each product of the plurality of products comprises a record with a plurality of fields of product characteristics including a first field comprising a number of units of the product and a second field comprising a cost of goods sold (COGS) of the product;
declaring a model for an allocation of the plurality of products to the plurality of choice groups;
creating a plurality of loops, where
a first loop is defined to perform a number of iterations equal to the number of choice groups, and
a second loop is nested by the first loop and defined to perform a number of iterations equal to the number of products, wherein
a plurality of constraints is added to the model for one product of the plurality of products with each iteration of the first loop, where
each constraint of plurality of constraints is added as a function of a decision variable of the one product and one of the plurality of fields,
defining a solver objective function as a minimizing function of a decision variable comprising a plurality of binary values and the plurality of COGS-based penalty values for each product to minimize a global penalty of product allocation to the plurality of choice groups, where
the solver objective function is applied for the model constructed from a plurality of constraints determined from the plurality of fields for the plurality of products; and
calling the solver, such that
a plurality of status values for the allocation is returned, whereby
each status value of the plurality of status values indicates to a user whether the model produces an optimal or feasible allocation of products as determined by the solver.

15. The constraint-based method of claim 14, further comprising:
creating a plurality of loops prior to the model being declared, where
a third loop is defined to perform a number of first iterations in which a first elasticity of a plurality of elasticities is increased with each first iteration, where
the data is further representative of the plurality of elasticities,
a fourth loop is nested within the third loop and defined to perform a number of second iterations in which a second elasticity of the plurality of elasticities is increased with each second iteration, and
a fifth loop is nested within the fourth loop and defined to perform a number of third iterations in which a third elasticity of the plurality of elasticities is increased with each third iteration.

16. The constraint-based method of claim 15, wherein
lower and upper bounds of a first constraint of the plurality of constraints decrease and increase, respectively, with each iteration of the third loop,
lower and upper bounds of a second constraint of the plurality of constraints decrease and increase, respectively, with each iteration of the fourth loop, and
lower and upper bounds of a third constraint of the plurality of constraints decrease and increase, respectively, with each iteration of the fifth loop.

17. The constraint-based method of claim 14, further comprising:
determining the plurality of COGS-based penalty values for each product as a function of the product's COGS and a plurality of percentile values determined from all of the second fields of the plurality of products.

18. The constraint-based method of claim 17, wherein a lowest penalty value and a highest penalty value of the plurality of COGS-based penalty values are determined for each product.

19. The constraint-based method of claim 18, wherein the lowest penalty value and the highest penalty value are determined from the plurality of percentile values.

20. The constraint-based method of claim 14, wherein each penalty value of the plurality of COGS-based penalty values for each product corresponds to one choice group of the plurality of choice groups.
